(19) United States
(12) Patent Application Publication
(10) Pub. No.: US 2012/0280159 A1
(43) Pub. Date: Nov. 8, 2012

(54) Hydraulic Log Splitter Cylinder Control Valve

(75) Inventors: Yuxin Lu, Jiaxing City (CN); Zhongcheng Peng, Jiaxing City (CN); Songfu Hu, Jiaxing City (CN)

(73) Assignee: Jiashan Superpower Tools Co., Ltd., Jiaxing City (CN)

(21) Appl. No.: 13/466,055

(22) Filed: May 7, 2012

Related U.S. Application Data
(60) Provisional application No. 61/483,621, filed on May 6, 2011.

(30) Foreign Application Priority Data
May 5, 2011 (CN) 201120139690.0

(51) Int. Cl. F16K 31/44

(52) U.S. Cl. 251/231

(57) ABSTRACT

A log splitter hydraulic cylinder control valve comprises a valve body comprising one or more openings, oil pathways and steps; a screwed spool engaged with the valve body, a valve seat connected with the spool, a torsion spring disposed between the valve body and a handle mount, and a handle connected to the handle mount, wherein turning the handle operates the screwed spool to turn and block or unblock an oil pathway inside the valve body to force oil to enter the cylinder or for oil to return to an oil tank. The spool includes coarse portion having threads, a spline joint which connects to the handle, and a ball head. The valve seat has an internal bore having coarse threads and threads on the outer surface. Dual-handle control is obtained when two steps are added on the valve body and two screwed valves are installed.

### CROSS-REFERENCE TO RELATED APPLICATIONS

This application claims priority to U.S. Provisional patent application no. 61/483,621 filed on May 6, 2011; and further claims foreign priority under 35 U.S.C. §119 to Chinese Patent Application no. 201120139690.0, filed in the People's Republic of China on May 5, 2011, which are hereby incorporated by reference for all purposes.

### TECHNICAL FIELD

This invention relates to a cylinder control valve used in electric or motorized log splitters. In particular, this invention relates to the control valve in a single-acting hydraulic cylinder, and more specifically, a screwed valve.

### BACKGROUND

There are many types of log splitters, including manual, pneumatic, electric, and motorized log splitters, which are widely used in the European, American and Australian logging industries. Wood is a green sustainable energy source, and these countries use wood as a source of heating. Therefore, many farms and families need and use log splitters. Currently, domestic-made and foreign-made log splitters usually have a power unit, control valve, driving cylinder and beam. The control unit varies with the type of driving power or actuator cylinder. Based on the structure, there are Spool Rotary Valves, Disc Rotary Valves and Sliding Spool Valves; based on function, there are 3-way-2-position Valves or 4-way-3-position Valves. Functionally, all these valves can meet the requirements of a log splitter. However, the requirement for accurate coordination between a spool and valve plate is high and so is the manufacturing cost. Such current valves have a low ability to protect from contamination of the hydraulic oil.

Accordingly, there is a need for a log splitter hydraulic cylinder control valve, which has a simple manufacturing process, is low in manufacturing cost, which inhibits contamination, is reliable and is easy to operate.

### SUMMARY

According to an embodiment of the present invention, there is provided a log splitter hydraulic cylinder control valve comprising: a valve body (a cylinder back cap or valve plate), a screwed spool, a valve seat, a torsion spring, a handle mount, and a handle.

According to an embodiment, the log splitter hydraulic cylinder control valve or screwed valve comprises: a valve body comprising one or more openings, one or more oil pathways and one or more steps; a screwed spool engaged with the valve body, a valve seat connected with the spool, a torsion spring disposed between the valve body and a handle mount, and a handle connected to the handle mount, wherein turning the handle operates the screwed spool to turn and block an oil pathway inside the valve body to force oil to enter the cylinder.

Moreover, in the embodiment of the present invention, releasing the handle engages torsion spring to operate the screwed spool to turn and unblock an oil pathway inside the valve body for oil to return to an oil tank.

When two steps are added on the valve body and two screwed valves are installed, dual-handle control can be performed according to an embodiment of the present invention.

These features, advantages and other embodiments of the present invention are further made apparent, in the remainder of the present document, to those of ordinary skill in the art.

### BRIEF DESCRIPTION OF THE DRAWINGS

To further describe embodiments of the present invention, reference is made to the accompanying drawings. These drawings are not to be considered limitations in the scope of the invention, but are merely illustrative.

FIG. 1 is the control valve system schematic cross-section, according to an embodiment of the present invention.

FIG. 2 is a perspective exploded view of the control valve system, according to an embodiment of the present invention.

FIG. 3 illustrates the valve plate pathway, according to an embodiment of the present invention.

FIG. 4 is a perspective view of the valve screwed spool, according to an embodiment of the present invention.

FIG. 5 is a perspective view of the valve seat, according to an embodiment of the present invention.

### DETAILED DESCRIPTION OF SPECIFIC EMBODIMENTS

The description above and below and the drawings of the present document focus on one or more example embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

An object of one aspect of the invention is to provide a log splitter hydraulic cylinder control valve, which has a simple manufacturing process, low manufacturing cost, high anti-contamination capability, good reliability, and easy operating process. Advantageously, this valve can be assembled on a back cap of the cylinder, reducing overall manufacturing cost of the log splitter, and can be used in log splitters of different sizes and different driving power. By using this valve, dual-handle control can easily be implemented on the log splitter. Below is a detailed description of the core components of the control/screw valve according to one or more embodiments of the present invention.

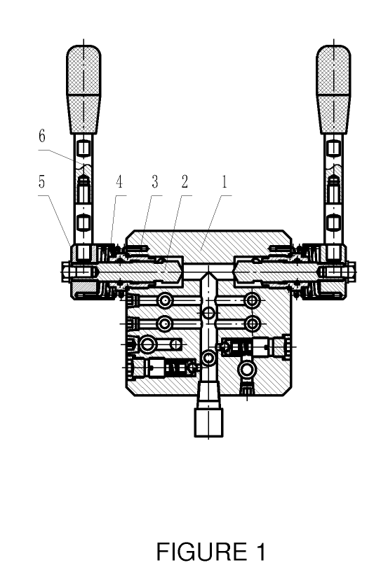

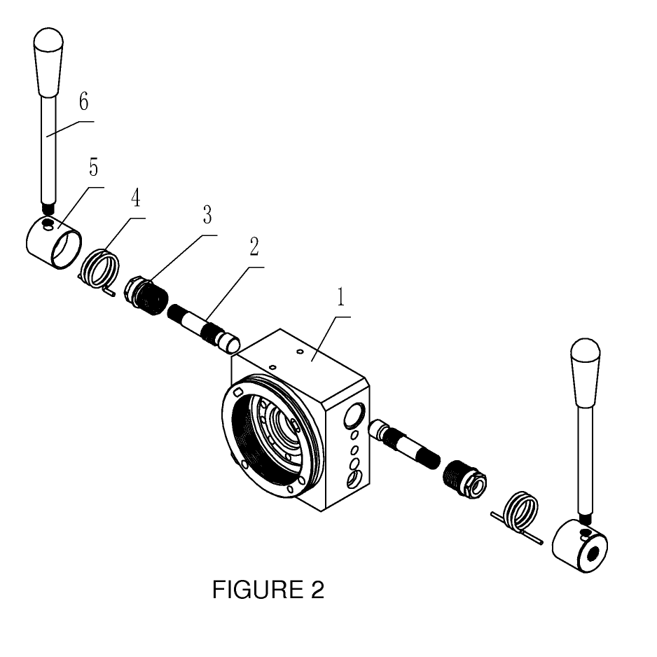

As illustrated in FIGS. 1 and 2, to carry out the objects of the invention, there is provided a log splitter hydraulic cylinder control valve comprising: a valve body 1 (also described as a cylinder back cap or a valve plate), a screwed spool 2, a valve seat 3, a torsion spring 4, a handle mount 5, and a handle 6, according to an embodiment of the present invention.

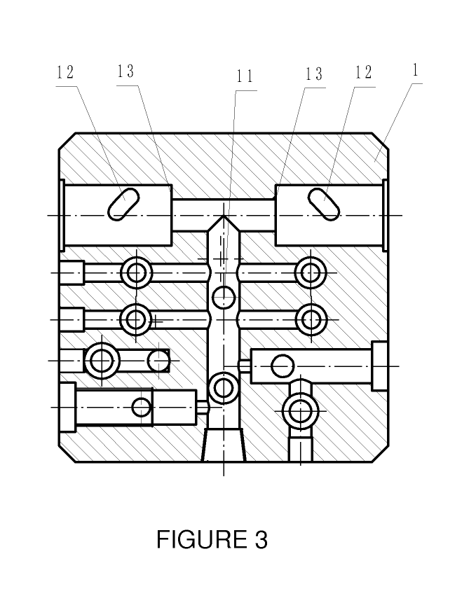

As illustrated in FIG. 3, among the openings on the valve body 1 between the oil pathway 11, which moves oil from the valve body 1 to the cylinder, and the oil pathway 12, which moves oil from the valve body 1 to the oil tank, there are different sizes of steps 13.

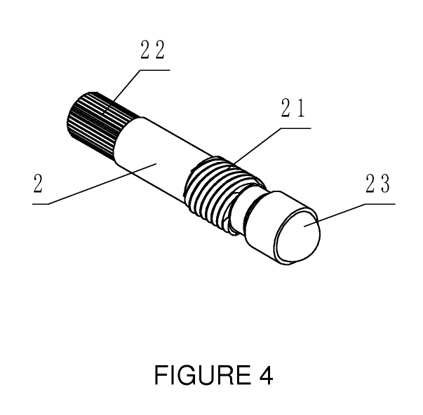

FIG. 4 shows a perspective view of the screwed spool 2. The spool 2 includes coarse portion having threads 21, a spline joint 22 which connects to the handle, and a ball head 23.

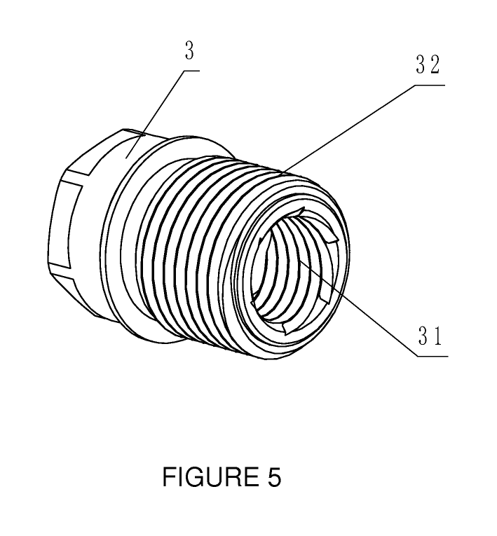

As shown in FIG. 5, valve seat 3 has an internal bore having coarse threads 31. The valve seat 3 and valve body 1 are fastened together through threads 32 on the outer surface of the valve seat 3 which is in the same direction as the control valve; and the direction of threads 32 is the same as coarse threads 31.

The torsion spring 4 is disposed between handle mount 5 and valve body 1. The direction of the torsion spring is the same as the operating direction of the valve.

Through the above embodiments, the present invention comprises the following features: the handle 6 turns and, through the handle mount 5, turns screwed spool 2; then, under the action of coarse threads 21 and 31, presses ball head 23 to step 13 and blocks oil pathway 12 so oil can only enter into the cylinder to push the cylinder forward. When the handle is released, the torsion spring 4 puts screwed spool 2 under the action of coarse threads 21 and 31, and step 13 and ball head 23 are set apart, then the oil directly returns to the oil tank; and the log splitter cylinder, under the restoring spring force, automatically returns. This process easily finishes the operating cycle of the log splitter. When two steps 13 are added on the valve body and two screwed valves are installed, dual-handle control can be performed according to an embodiment of the present invention.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A log splitter hydraulic cylinder control valve or screwed valve comprising:
a valve body comprising one or more openings, one or more oil pathways and one or more steps;
a screwed spool engaged with the valve body,
a valve seat connected with the spool,
a torsion spring disposed between the valve body and a handle mount, and
a handle connected to the handle mount,
wherein turning the handle operates the screwed spool to turn and block an oil pathway inside the valve body to force oil to enter the cylinder.

2. The log splitter hydraulic cylinder control valve according to claim 1, wherein the screwed spool further comprises a coarse threaded portion, a spline joint which connects to the handle, and a ball head which engages the valve body.

3. The log splitter hydraulic cylinder control valve according to claim 1, wherein the valve seat has an internal bore having coarse threads and a threaded outer surface; the valve seat and valve body are fastened together through the threaded outer surface which is threaded at the same direction as an operating direction of the control valve and the coarse threads of the internal bore.

4. The log splitter hydraulic cylinder control valve according to claim 1, wherein a direction of the torsion spring is the same as an operating direction of the valve.

5. The log splitter hydraulic cylinder control valve according to claim 1, wherein
the screwed spool further comprises a coarse threaded portion at a first end, a spline joint at a second end which connects to the handle, and a ball head at the first end; and
the valve seat has an internal bore having coarse threads and a threaded outer surface.

6. The log splitter hydraulic cylinder control valve according to claim 5, wherein the handle turns the handle mount and the screwed spool together; and under action of the coarse threaded portion and the coarse threads of the internal bore, presses the ball head to a step in the valve body and blocks an oil pathway, thereby the oil can only enter into the cylinder to push the cylinder forward.

7. A log splitter hydraulic cylinder control valve or screwed valve comprising:
a valve body comprising one or more openings, one or more oil pathways and one or more steps;
a screwed spool engaged with the valve body,
a valve seat connected with the spool,
a torsion spring disposed between the valve body and a handle mount, and
a handle connected to the handle mount,
wherein releasing the handle operates the torsion spring to engage the screwed spool to turn and unblock an oil pathway inside the valve body for oil to return to an oil tank.

8. The log splitter hydraulic cylinder control valve according to claim 7, wherein the screwed spool further comprises a coarse threaded portion, a spline joint which connects to the handle, and a ball head which engages the valve body.

9. The log splitter hydraulic cylinder control valve according to claim 7, wherein the valve seat has an internal bore having coarse threads and a threaded outer surface; the valve seat and valve body are fastened together through the threaded outer surface which is threaded at the same direction as an operating direction of the control valve and the coarse threads of the internal bore.

10. The log splitter hydraulic cylinder control valve according to claim 7, wherein a direction of the torsion spring is the same as an operating direction of the valve.

11. The log splitter hydraulic cylinder control valve according to claim 7, wherein
the screwed spool further comprises a coarse threaded portion at a first end, a spline joint at a second end which connects to the handle, and a ball head at the first end; and
the valve seat has an internal bore having coarse threads and a threaded outer surface.

12. The log splitter hydraulic cylinder control valve according to claim 11, wherein when the handle is released,
the torsion spring puts the screwed spool under an action of the coarse threaded portion and the coarse threads of the internal bore,
a step in the valve body and the ball head are set apart, therein oil directly returns to an oil tank; and
the log splitter cylinder, under a restoring spring force, automatically returns.

13. A log splitter hydraulic cylinder control valve or screwed valve comprising:
a valve body comprising one or more openings, one or more oil pathways and one or more steps;
a pair of screwed spools engaged with the valve body,
a pair of valve seats, each valve seat connected with each respective spool,
a pair of handle mounts,
a pair of torsion springs, each spring disposed between the valve body and each respective handle mount, and
a pair of handles, each handle connected to each respective handle mount,
wherein turning either of the pair of handles operates the respective screwed spool to turn and block an oil pathway inside the valve body to force oil to enter the cylinder.

14. The device according to claim 14 wherein when either of the pair of handles is released,
torsion spring puts the screwed spool under an action of the coarse threaded portion and the coarse threads of the internal bore,
a step in the valve body and the ball head are set apart, therein oil directly returns to an oil tank.
